(19) United States
(12) Patent Application Publication
(10) Pub. No.: US 2004/0184360 A1
(43) Pub. Date: Sep. 23, 2004

(54) Apparatus and method for controlling a disc player

(76) Inventors: Tsu-Hsing Chen, Hsinchu (TW); Hsin-Jung Chuang, Hsinchu (TW); Jiun-Shiung Chen, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/800,827

(22) Filed: Mar. 15, 2004

(30) Foreign Application Priority Data
Mar. 19, 2003 (TW) 92106251

(51) Int. Cl. H04B 1/20

(52) U.S. Cl. 369/1

(57) ABSTRACT

The present invention discloses an apparatus and method for controlling a disc player. The disc player comprises at least one optical drive and a card reader. Image files output by the card reader are transferred to video signals and showed on TV screen for editing. Furthermore, the disclosed disc player has a function of time division multiplexing. When disc player is operating in a soundless operation mode and there is a music disc loaded in the optical drive, the disc player will play the music disc at the same time. In this way, the user can listen to the music by using a music disc loaded into the optical drive when the disc player is operated in the soundless operation mode.

### BACKGROUND OF THE INVENTION

1. Field of the Invention

The present invention relates to an apparatus and a method for controlling a disc player, and in particular to an apparatus and a method for controlling a disc player capable of showing or editing image files on a screen and playing music at the same time.

2. Description of the Prior Art

As the development of the technologies, video players have made a great progress from video tape players to laser disc (LD) players. Today, DVD players are the mainstream in the player market. Also, the DVD player can play many kinds of data formats such as CD-DA music data, MPEG 3 (MP3) music data, DVD multi-media data or VCD multi-media data.

In order to attract more consumers, some player manufacturers combine additional hardware into the DVD players. For example, one card reader is combined into a DVD player for reading image files, which are captured from the digital camera or other peripherals. Instead of shown or edited the image files on the a displayer of a computer, images files can be shown or edited on the TV screen by using the card reader embedded in the specific DVD players. The card reader can read files stored in the Secure Digital Card (SD card), Multi Media Card (MM card), Smart Media Card (SM card), Compact Flash Card (CF card), or Memory Stick Card (MS card).

In this kind of DVD players, the optical drive and the card reader both are individually controlled by the micro-controller. It means that when the images files are shown and edited on the TV screen by using the card reader, the optical drive of the specific DVD player is in idle state. There is no any additional function for the specific DVD player to active the optical drive.

### SUMMARY OF THE DISCLOSURE

It is an object of the present invention to provide an apparatus and a method for controlling a disc player. When the disc player is operated in a soundless operation mode, the user can also listen to the music at the same time.

The present invention provides a disc player, comprising: an optical drive for reading data from a disc; a card reader for reading image files from a card; and a micro-controller connected to the optical drive and the card reader for receiving data or image files; wherein when the micro-controller is operated in a soundless operation mode, the optical drive is activated to output an audio data and the micro-controller may transfer the audio data to audio signals for playing.

The present invention provides a disc player, comprising: at least one optical drive for reading data from a disc; a card reader for reading data from a card; and a micro-controller connected to the at least one optical drive and the card reader for receiving data from the at least one optical drive or the card reader; wherein when the micro-controller is operated in a soundless operation mode, if one of the at least one optical drive and the card reader may provide an audio data to the micro-controller, the micro-controller transfer the audio data to audio signals for playing.

The present invention provides a method of controlling a disc player used in a soundless operation mode, comprising the steps of: activating a plurality of hardware for providing at least one audio data; and if one of the hardware being capable of providing the at least one audio data, transferring the audio data to audio signals for playing.

### BRIEF DESCRIPTION OF THE DRAWINGS

The present invention can be fully understood from the following detailed description and preferred embodiment with reference to the accompanying drawings in which:

FIG. 1 shows the structure of the disc player according to the first embodiment;

FIG. 2 shows the structure of the player according to the second embodiment; and

FIG. 3 shows the follow chart according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

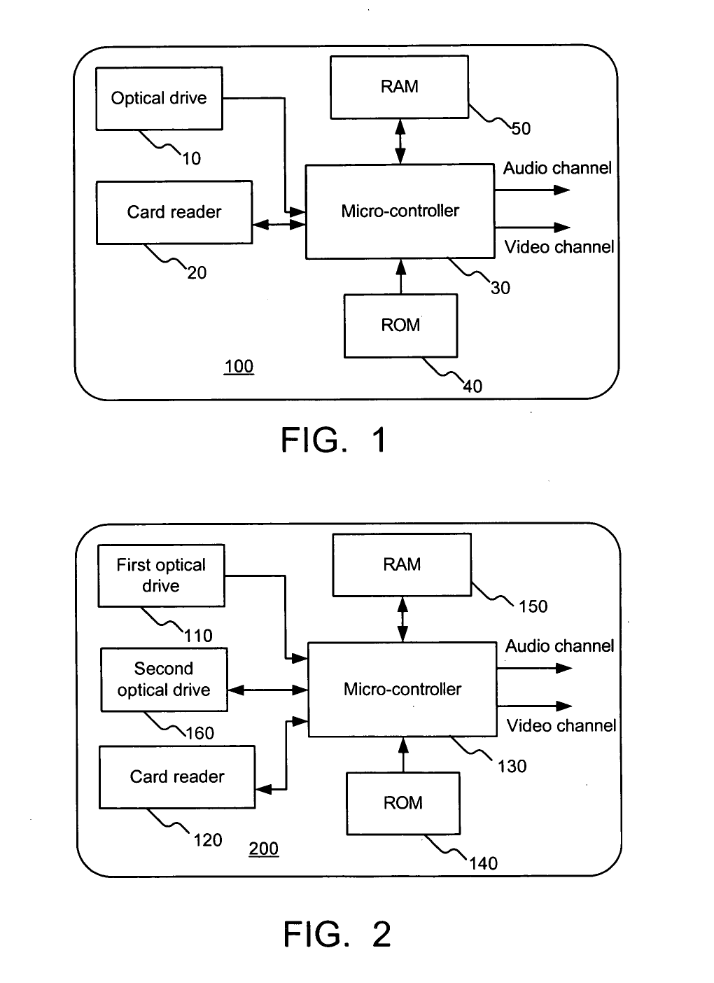

FIG. 1 shows the structure of the disc player according to the first embodiment. The disc player 100 includes an optical drive 10, a card reader 20, a micro-controller 30, a read only memory (ROM) 40, a random access memory (RAM) 50. Further, the user may connect the video channels to the TV and the audio channels to the speakers. Generally speaking, the ROM 40 stores firmware capable of controlling the micro-controller 30 to execute all functions that the player has and the RAM 50 temporarily stores random data that generated by the micro-controller 30. Also, the optical drive 10 is a DVD optical drive or a VCD optical drive.

According to the first embodiment, the optical drive 10 reads data from an optical disc and output the data to the micro-controller 30 by using the format of ATA/ATAPI interface. If the optical disc contains MPEG data, the micro-controller 30 then decodes the MPEG data and generates video signals and audio signals. The video channels and the audio channels of the micro-controller 30 output the video signals and the audio signals. In this way, the video signals are shown on TV screen and the audio signals are played by the speakers. If the optical disc contains the MP3 files or CD-DA music data, the micro-controller 30 then decodes the MP3 files or CD-DA data and outputs only audio signals to the speakers. In this way, only the audio signals are played by the speakers.

Further, the disc player 100 has a card reader 20 controlled by the micro-controller 30. If user inserts one card into the card reader 20, data stored in the card is read out and is transmitted to the micro-controller 30 by using the format of ATA/ATAPI interface. If the data stored in the card contains image files such as JPEG image file, the micro-controller 30 decodes the JPEG image files and outputs only video signals to the TV. If the data stored in the card contains MP3 files, the micro-controller 30 then decodes the MP3 files and outputs only audio signals to the speakers.

Some functions of the disc player 100 only output video signals such as showing or editing image files on TV screen. This kind of functions belongs to a soundless operation mode. According to the present embodiment, when disc player 100 operates in the soundless operation mode, the micro-controller 30 may activate optical drive 10 to transmit data for generating audio signal at the same time. For example, if card reader 20 is outputting image files to micro controller 30 for generating video signals to the TV screen and a music disc is loaded into the optical drive 10, at this time the micro-controller 30 activates optical drive 10 to transmit music data and generate audio signals to the speakers. In this way, user can watch or edit image files and listen to the music at the same time.

Using the firmware having time division multiplexing procedure, the micro-controller 30 alternatively actives optical drive 10 and card reader 20 in a short time period. In this way, the micro-controller 30 has multi-tasking control to activate different hardware at the same time and output audio signals and the video signal smoothly.

FIG. 2 shows the structure of the player according to the second embodiment. The player disc 200 includes a first optical drive 110, a second optical drive 160, a card reader 120, a micro-controller 130, a read only memory (ROM) 140, a random access memory (RAM) 150. The user may connect the video channels to the TV and the audio channels to the speakers. Generally speaking, the ROM 140 stores firmware capable of controlling the micro-controller 130 to execute all functions that the player has and the RAM 150 temporarily stores random data that generated by the micro-controller 130. Also, the first optical drive 110 is a read only optical drive and the second optical drive 160 is a recordable optical drive.

According to the second embodiment, the soundless operation modes include the following functions,

(I) The second optical drive is duplicating a new disc by copying data from the source hardware of either the first optical drive 110 or the card reader 120.

(II) The card reader 120 is outputting image file to the micro-controller 130 for generating video signals to TV.

(III) The first optical drive 110 or the second optical drive 160 contains image files and is outputting image files to the micro-controller 130 for generating video signals to TV.

In case (I) and (III), if the card stored MP3 file inserts into the card reader 120, the micro-controller 130 activates the card reader 120 to output the MP3 files and generates audio signals. In case (II), if a music disc inserts into one of the optical drives, the micro-controller 130 activates the specific optical drive to output the music data and generates audio signals.

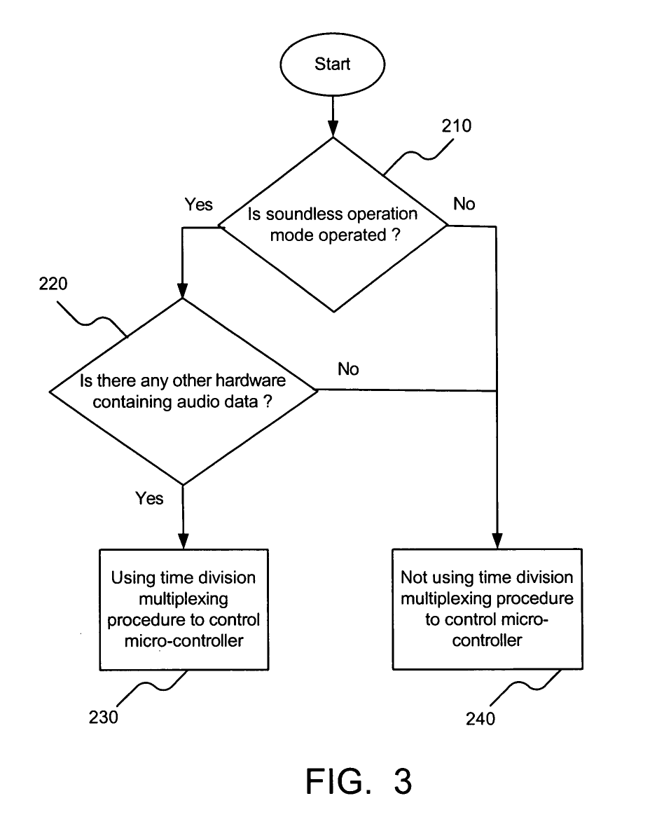

FIG. 3 shows the follow chart according to the present invention. Firstly, check whether a soundless operation mode is operated by the disc player (Step 210). If the soundless operation mode is not operating, the micro-controller is controlled normally and does not be controlled by using time division multiplexing procedure (Step 240). If the soundless operation mode is operating, the micro-controller activates other hardware to check whether any hardware may provide audio data (Step 220). If one hardware contains audio data, using the time division multiplexing procedure to control the micro-controller (Step 230). If no any hardware contains audio data, the micro-controller is controlled normally and does not be controlled by using time division multiplexing procedure (Step 240).

According to the present invention, the micro-controller of the disc player actives different hardware by using the control of firmware having time division multiplexing procedure. When the player is operated in a soundless operation mode, the micro-controller of the controller may activate other hardware to output audio data for generate audio signal.

While the invention has been described with reference to a preferred embodiment, the description is not intended to be construed in a limiting sense. It is therefore contemplated that the appended claims will cover any such modifications or embodiments as may fall within the scope of the invention defined by the following claims and their equivalents.

What is claimed is:

1. A disc player, comprising:
an optical drive for reading data from a disc;
a card reader for reading image files from a card; and
a micro-controller connected to said optical drive and said card reader for receiving data or image files from said optical drive or said card reader;
wherein when said micro-controller is operated in a soundless operation mode, said optical drive is activated to output an audio data and said micro-controller may transfer the audio data to audio signals for playing.

2. The disc player as claimed in claim 1, wherein said audio data is a CD-DA format data or a MP3 file.

3. The disc player as claimed in claim 1, wherein said card is selected from a SD card, a MMC card, a SM card, a CF card, and a MS card.

4. The disc player as claimed in claim 1, wherein said optical drive is a DVD optical drive or a CD optical drive.

5. The disc player as claimed in claim 1, wherein said soundless operation mode includes showing or editing said image files on a TV screen.

6. A disc player, comprising:
at least one optical drive for reading data from a disc;
a card reader for reading data from a card; and
a micro-controller connected to said at least one optical drive and said card reader for receiving data from said at least one optical drive or said card reader;
wherein when said micro-controller is operated in a soundless operation mode, if one of said at least one optical drive and said card reader may provide an audio data to said micro-controller, said micro-controller transfer said audio data to audio signals for playing.

7. The disc player as claimed in claim 6, wherein said audio data is CD-DA format data or a MP3 file.

8. The disc player as claimed in claim 6, wherein said card is selected from a SD card, a MMC card, a SM card, a CF card, and a MS card.

9. The disc player as claimed in claim 6, wherein said at least one optical drive is a DVD optical drive, a CD optical drive, a DVD recordable optical drive, or a CD recordable optical drive.

10. The disc player as claimed in claim 6, wherein said soundless operation mode includes showing or editing data stored in said card on a TV screen.

11. The disc player as claimed in claim 6, wherein said soundless operation mode includes copying data from said card reader to said at least one optical drive.

12. A method of controlling a disc player used in a soundless operation mode, comprising the steps of:
activating a plurality of hardware for providing at least one audio data; and
if one of said hardware being capable of providing said at least one audio data, transferring said audio data to audio signals for playing.

13. The method as claimed in claim 12, wherein said hardware includes at least one optical and a card reader.

14. The method as claimed in claim 13, wherein said card reader is capable of reading card selected from a SD card, a MMC card, a SM card, a CF card, and a MS card.

15. The method as claimed in claim 13, wherein said at least one optical drive is a DVD optical drive, a CD optical drive, a DVD recordable optical drive, or a CD recordable optical drive.

16. The method as claimed in claim 12, wherein said audio data includes a MP3 file or a CD-DA music format data.
